(19) United States
(12) Patent Application Publication
(10) Pub. No.: US 2013/0010085 A1
(43) Pub. Date: Jan. 10, 2013

(54) THREE-DIMENSIONAL IMAGE DISPLAY DEVICE, THREE-DIMENSIONAL IMAGING DEVICE, TELEVISION RECEIVER, GAME DEVICE, RECORDING MEDIUM, AND METHOD OF TRANSMITTING THREE-DIMENSIONAL IMAGE

(76) Inventor: Yoshiki Takata, Osaka-shi (JP)

(21) Appl. No.: 13/634,769

(22) PCT Filed: Jan. 19, 2011
(86) PCT No.: PCT/JP2011/050882

§ 371 Date: Sep. 13, 2012

(30) Foreign Application Priority Data
Mar. 16, 2010 (JP) 2010-059475

(51) Int. Cl. H04N 13/04; H04N 13/02

(52) U.S. Cl. 348/47; 348/51; 348/E13.026; 348/E13.074

(57) ABSTRACT

A right-eye image n+½ is an image that interpolates between a left-eye image n and a left-eye image n+1. This makes it possible to achieve a stereoscopic image display device capable of carrying out a stereoscopic display with improved display quality of moving images and improved viewability of moving images.

### TECHNICAL FIELD

The present invention relates to a stereoscopic image display device which displays left-eye and right-eye images with binocular parallax, a stereoscopic image pickup device for acquiring data for the left-eye image and data for the right-eye image, a television receiver including such a stereoscopic image display device, a game apparatus including such a stereoscopic image display device, a recording medium containing the data for the left-eye image and the data for the right-eye image, and a stereoscopic image transmitting method for transmitting the data for the left-eye image and the data for the right-eye image.

### BACKGROUND ART

The eyes of a human are approximately 6.5 cm apart, which causes a slight difference between an image seen by the left eye and an image seen by the right eye. This phenomenon is called “binocular parallax”.

While the left eye and the right eye see different images, respectively, the human brain recognizes these two different images as a single image. It is in this process that humans feel a sense of stereoscopic vision.

Therefore, when the eyes of a person see exactly the same images, the person feels that the resulting image is being displayed on the screen of the display device; on the other hand, when the left and right eyes of a person see images having a slight difference in horizontal position from each other, the person feels a sense of stereoscopic vision as if the resulting image were in the back of the screen of the display device or popped up from the screen of the display device.

Conventionally, there have been proposed various methods for displaying a three-dimensional image that gives a sense of stereoscopic vision. Among them, methods that utilize the aforementioned binocular parallax have been widely and heavily used.

Among the methods that utilize the principle of binocular parallax, the most heavily used methods are methods that utilize special glasses, and well-known examples of such methods include a red-and-blue glasses method (anaglyph method), a polarized glasses method (passive glasses method), a shutter glasses method (active glasses method), and the like.

The red-and-blue glasses method is a method that gives a sense of stereoscopic vision by producing left-right parallax by separating left-eye and right-eye images from each other with use of red-and-blue glasses.

The polarized glasses method is a method for causing left-eye and right-eye images to be alternately displayed every other horizontal line on the display surface of the display device, with polarizing films attached to the display surface of the display device so that the left and right images can be separated every horizontal line, and with the viewer wearing polarized glasses so that he/she can recognize the left-eye and right-eye images separately.

Further, the shutter glasses method is a method for causing left-eye and right-eye images to be alternately displayed at twice the normal speed (at twice as high a frequency) on the display device and, at the same time, transmitting a synchronizing signal to shutter glasses so that light from the display surface of the display device is transmitted to or blocked from the viewer in a constant cycle with use of the shutter glasses, thereby causing the viewer to recognize the left-eye and right-eye images separately. That is, when a left-eye image is displayed on the display device, the shutter glasses allow the viewer to see the left-eye image with his/her left eye alone; on the other hand, when a right-eye image is displayed on the display device, the shutter glasses allow the viewer to see the right-eye image with his/her right eye alone.

In addition to the methods that utilize special glasses, a parallax barrier method, a lenticular method, and the like are known by which a stereoscopic picture can be displayed without use of glasses.

The parallax barrier method is a method for causing left-eye and right-eye images to be alternately displayed every other horizontal line on the display surface of the display device, with a parallax barrier placed on the display surface of the display device, the parallax barrier being in the form of slits each having a width narrower than the size of a single pixel on the display surface of the display device. This allows the viewer to see a left-eye image with his/her left eye alone and see a right-eye image with his/her right eye alone, with the result that the viewer feels a sense of stereoscopic vision.

Further, as with the parallax barrier method, the lenticular method is a method for carrying out a stereoscopic display, with a lenticular lens placed on the display surface of the display device instead of a parallax barrier.

Among the methods that carry out a stereoscopic display, the shutter glasses method is excellent in terms of color reproducibility, luminance, intensity of a sense of stereoscopic vision, viewing angle dependency, etc., and has been under active study.

In recent years, a large number of attempts have been made, in particular, to improve the quality of a stereoscopic image on a stereoscopic image display apparatus based on the shutter glasses method.

For example, Patent Literature 1 discloses a stereoscopic image display device based on the shutter glasses method, which stereoscopic image display device can prevent ghosts and flickers on stereoscopic images and can give stereoscopic images with less decrease in emission luminance.

FIG. 10 is a timing chart showing a relationship between an operating state of liquid crystal shutters serving as shutter glasses and a display state of left-eye and right-eye images on a liquid crystal display device serving as a display device according to a conventional technology.

On the side of the liquid crystal shutters serving as the shutter glasses, as shown in FIG. 10, when a left-eye liquid crystal shutter driving signal DL generated by a synchronous circuit in accordance with a video signal SL is inputted to a left-eye liquid crystal shutter (left-eye part of the shutter glasses), the left-eye liquid crystal shutter comes into an ON state in which to transmit light only for a single frame period (1/f=12.5 ms, f: drive frequency=80 Hz), so that the left-eye image is transmitted.

Meanwhile, on the side of the liquid crystal display device serving as the display device, 1 to n scanning lines need to be scanned for equal hold periods (Th₁ to Thₙ), respectively, so that the left-eye image is displayed. At this point in time, a larger lag occurs in scanning start time as an increasing number of the scanning lines, as shown in FIG. 10, due to a problem with response time peculiar to liquid crystals used in the liquid crystal display device.

Therefore, in the case of scanning of the 1 to n scanning lines for the hold periods (Th₁ to Thₙ), the finish time (Rₙ) of the hold period for the nth scanning line, for example, lags behind the display time of the right-eye image, i.e., the start time (Ts₁) of switching by liquid crystal optical switching means.

In such a case, consequently, the left-eye image and the right-eye image are displayed simultaneously, so that a ghost occurs. Such a problem could be avoided by shortening the hold periods (Th₁ to Thₙ) for the scanning lines. However, shortening of the hold periods presents a new problem of decrease in emission luminance accordingly.

In view of these problems, Patent Literature 1 discloses a stereoscopic image display device based on the shutter glasses method with remedies for these problems.

FIG. 11 is a timing chart showing a relationship between an operating state of liquid crystal shutters serving as shutter glasses and a display state of left-eye and right-eye images on a liquid crystal display device serving as a display device according to a stereoscopic image display device based on the shutter glasses method as disclosed in Patent Literature 1.

In the configuration of Paten Literature 1, as shown in FIG. 11, the finish time (Rₙ) of the hold period for the nth scanning line, where scanning finishes, is matched with the start time (Ts₁) of switching by liquid crystal optical switching means or set to lead the start time.

Such a configuration allows the display of the left-eye image to finish within a period of switching from the ON state of the left-eye liquid crystal shutter to the ON state of the right-eye liquid crystal shutter.

Therefore, the left-eye image and the right-eye image are no longer displayed around the same time, so that such a ghost image can be effectively prevented.

Further, according to the configuration of Patent Literature 1, since the hold period (Thₙ) for the nth scanning line takes on a value of 80% or more of the hold period (Th₁) for the first scanning line, the difference in amount of emission between one scanning line and another is 20% at a maximum. This makes it possible to reduce decreases, variations, etc. in emission luminance in the scanning lines and, as a result, makes it possible to reduce a distribution of luminance in the scanning direction to such an extent that there is no problem with a sense of vision.

In FIGS. 10 and 11, Qₙ indicates a point in time at which to start to scan, for example, the nth scanning line by applying a predetermined voltage as a write pulse to the nth scanning line the time Pₙ after the start time Q₁ of the hold period for the first scanning line.

### CITATION LIST

### Patent Literature 1

Japanese Patent Application Publication, Tokukai, No. 2001-154640 A (Publication Date: Jun. 8, 2001).

### SUMMARY OF INVENTION

### Technical Problem

The stereoscopic image display device based on the shutter glasses method as disclosed in Patent Literature 1 can prevent ghosts and flickers on stereoscopic images and can give stereoscopic images with less decrease in emission luminance, but Patent Literature 1 pays no attention to the fact that there occurs a difference between a point in time to see a left-eye image with the left eye and a point in time at which to see a right-eye image with the right eye.

In the following, problems with the occurrence of a difference between a point in time to see a left-eye image with the left eye and a point in time at which to see a right-eye image with the right eye are explained in detail with reference to FIGS. 12 and 13.

FIG. 12 is a diagram showing the case of a ball moving from an upper left portion of the drawing to a lower right portion in a single frame period. The dotted ball indicates the position of the ball after a ½ frame period.

FIG. 13 is a diagram showing left-eye and right-eye images that are supplied to the stereoscopic image display device in the case of FIG. 12.

Since such a conventional configuration as that disclosed in Patent Literature 1 pays no the occurrence of a difference between a point in time to see a left-eye image with the left eye and a point in time at which to see a right-eye image with the right eye, the configuration does not reflect the actual motion of the ball based on the difference.

In the configuration, more specifically, a left-eye image n ((a) of FIG. 13) and a right-eye image n ((b) of FIG. 13) with binocular parallax as acquired simultaneously when the ball was in the upper left portion and a left-eye image n+1 ((c) of FIG. 13) and a right-eye image n+1 ((d) of FIG. 13) with binocular parallax as acquired simultaneously when the ball was in the lower right portion a single frame period after the ball had been in the upper left portion are alternately displayed in sequence.

That is, to the stereoscopic image display device, the left-eye image n, the right-eye image n, the left-eye image n+1, and the right-eye image n+1, which are shown in FIG. 13, are supplied in sequence.

Thus, the conventional stereoscopic image display device based on the shutter glasses method is configured such that although there is a difference in time between a point in time at which the viewer sees the left-eye image n and a point in time at which the viewer sees the right-eye image n and the ball changes its position during the difference in time, the right-eye image n, which is supplied to the stereoscopic image display device after the left-eye image n, does not reflect the position of the ball having moved.

Therefore, a stereoscopic image display device based on the shutter glasses method is poor in display quality of moving images and in viewability of moving images.

The present invention has been made in view of the foregoing problems, and it is an object of the present invention to provide a stereoscopic image display device with improved display quality of moving images and improved viewability of moving images, a television receiver including such a stereoscopic image display device, a game apparatus including such a stereoscopic image display device, a stereoscopic image pickup device for acquiring data for the stereoscopic image, a recording medium containing the data for the stereoscopic image, and a stereoscopic image transmitting method for transmitting the data for the stereoscopic image.

### Solution to Problem

In order to solve the foregoing problems, a stereoscopic image display device of the present invention includes: a display section having a display surface on which left-eye and right-eye images are alternately displayed in a constant cycle, the left-eye and right-eye images being each an image taken from a different point of view from the other; and a light intensity adjusting section, placed between the display surface and the left and right eyes of a viewer who looks at the display surface, which adjusts an amount of emitted light from the display surface in synchronization with the constant cycle, so that the viewer is able to see the left-eye image with the left eye alone while the left-eye image is being displayed on the display surface and see the right-eye image with the right eye alone while the right-eye image is being displayed on the display surface, either of the left-eye and right-eye images being an image that interpolates between an image in the current frame of the other image and an image in the next frame of the other image.

Conventionally, since no attention has been paid to the fact that in a case where left-eye and right-eye images are alternately displayed in a constant cycle, there occurs a difference in time between a point in time at which to see the left-eye image with the left eye and a point in time at which to see the right-eye image with the right eye, image data acquired at the same timing has been used as the left-eye and right-eye images.

That is, since left-eye and right-eye image data with binocular parallax as acquired simultaneously are supplied in sequence to the conventional stereoscopic image display device and the conventional stereoscopic image display device displays the left-eye and right-eye image data, the conventional stereoscopic image display device is totally unable to deal with a change in image which may arise due to such a difference in time. As such, the conventional stereoscopic image display device is poor in display quality of moving images and in viewability of moving images.

On the other hand, the stereoscopic image display device of the present invention is configured such that either of the left-eye and right-eye images is an image that interpolates between an image in the current frame of the other image and an image in the next frame of the other image. This configuration makes it possible to display an image between an image in the current frame and an image in the next frame, while the conventional configuration has been unable to display such an image.

According to the foregoing configuration, either of the left-eye and right-eye images is displayed as an interpolating image between a display of the image in the current frame of the other image and a display of the image in the next frame of other image. This makes it possible to achieve a stereoscopic image display device capable of carrying out a stereoscopic display with improved display quality of moving images and improved viewability of moving images.

In order to solve the foregoing problems, a television receiver of the present invention includes such a stereoscopic image display device.

According to the foregoing configuration, the television receiver includes such a stereoscopic image display device. This makes it possible to achieve a television receiver capable of carrying out a stereoscopic display with improved display quality of moving images and improved viewability of moving images.

In order to solve the foregoing problems, a game apparatus of the present invention includes such a stereoscopic image display device.

According to the foregoing configuration, the game apparatus includes such a stereoscopic image display device. This makes it possible to achieve a game apparatus capable of carrying out a stereoscopic display with improved display quality of moving images and improved viewability of moving images.

Examples of the game apparatus include, but are not limited to, 3D game machines (game machines capable of displaying stereoscopic images), 3D karaoke, etc. In order to solve the foregoing problems, a recording medium of the present invention contains data for left-eye and right-eye images, the left-eye and right-eye images being each an image taken from a different point of view from the other, either of the left-eye and right-eye images being an image that interpolates between an image in the current frame of the other image and an image in the next frame of the other image.

The recording medium contains stereoscopic image data in which either of the left-eye and right-eye images is an image that interpolates between an image in the current frame of the other image and an image in the next frame of the other image. This makes it possible to carry out a stereoscopic display with improved display quality of moving images and improved viewability of moving images even when the stereoscopic image data in the recording medium is played back to be displayed on a stereoscopic image display device not including a separate image generating circuit or the like for generating an interpolating image.

In order to solve the foregoing problems, a method of the present invention for transmitting a stereoscopic image includes the step of transmitting data for left-eye and right-eye images, the left-eye and right-eye images being each an image taken from a different point of view from the other, either of the left-eye and right-eye images being an image that interpolates between an image in the current frame of the other image and an image in the next frame of the other image.

The method for transmitting a stereoscopic image transmits stereoscopic image data in which either of the left-eye and right-eye images is an image that interpolates between an image in the current frame of the other image and an image in the next frame of the other image. This makes it possible to carry out a stereoscopic display with improved display quality of moving images and improved viewability of moving images even when a stereoscopic image display device not including a separate image generating circuit or the like for generating an interpolating image receives and displays the stereoscopic image data.

A stereoscopic image pickup device of the present invention includes: a first image data pickup section which acquires image data of a subject; and a second image data pickup section which acquires image data of the subject from a different point of view, either of the first and second image data pickup sections acquiring image data at a different timing from the other image data pickup section.

In the stereoscopic image pickup device, for example, the first image data pickup section, which acquires image data for a left-eye image, and the second image pickup section, which acquires image data for a right-eye image, acquire the image data at different timings.

This makes it possible to carry out a stereoscopic display with improved display quality of moving images and improved viewability of moving images even when image data obtained by such a stereoscopic image display device is sent to and displayed on a stereoscopic image display device not including a separate image generating circuit or the like for generating an interpolating image.

### Advantageous Effects of Invention

In a stereoscopic image display device of the present invention, as described above, either of the left-eye and right-eye images is an image that interpolates between an image in the current frame of the other image and an image in the next frame of the other image.

Further, a television receiver of the present invention is configured to include such a stereoscopic image display device.

Further, a game apparatus of the present invention is configured to include such a stereoscopic image display device.

Further, a recording medium of the present invention is configured to contain data for left-eye and right-eye images, the left-eye and right-eye images being each an image taken from a different point of view from the other, either of the left-eye and right-eye images being an image that interpolates between an image in the current frame of the other image and an image in the next frame of the other image.

Further, a method of the present invention for transmitting a stereoscopic image includes the step of transmitting data for left-eye and right-eye images, the left-eye and right-eye images being each an image taken from a different point of view from the other, either of the left-eye and right-eye images being an image that interpolates between an image in the current frame of the other image and an image in the next frame of the other image.

Further, a stereoscopic image pickup device of the present invention is configured to include: a first image data pickup section which acquires image data of a subject; and a second image data pickup section which acquires image data of the subject from a different point of view, either of the first and second image data pickup sections acquiring image data at a different timing from the other image data pickup section.

This makes it possible to achieve a stereoscopic image display device with improved display quality of moving images and improved viewability of moving images, a television receiver including such a stereoscopic image display device, a game apparatus including such a stereoscopic image display device, a stereoscopic image pickup device for acquiring data for the stereoscopic image, a recording medium containing the data for the stereoscopic image, and a stereoscopic image transmitting method for transmitting the data for the stereoscopic image.

### BRIEF DESCRIPTION OF DRAWINGS

FIG. 1 is a diagram showing left-eye and right-eye images that are displayed on a display surface of a liquid crystal display panel of a stereoscopic image display device according to an embodiment of the present invention.

FIG. 2 is a diagram schematically showing a configuration of a stereoscopic image display device according to an embodiment of the present invention.

FIG. 3 is a diagram schematically showing a configuration of a stereoscopic image display device according to another embodiment of the present invention.

FIG. 4 is a diagram showing a function of a frame interpolation circuit of a stereoscopic image display device according to another embodiment of the present invention.

FIG. 5 is a diagram showing left-eye and right-eye images that are displayed on a display surface of a liquid crystal display panel of a stereoscopic image display device according to another embodiment of the present invention.

FIG. 6 is a diagram schematically showing a configuration of a stereoscopic image display device according to still another embodiment of the present invention.

FIG. 7 is a diagram showing a function of a frame interpolation circuit of a stereoscopic image display device according to still another embodiment of the present invention.

FIG. 8 is a diagram showing left-eye and right-eye images that are displayed on a display surface of a liquid crystal display panel of a stereoscopic image display device according to still another embodiment of the present invention.

FIG. 9 is a diagram showing an example of a television receiver including a stereoscopic image display device according to an embodiment of the present invention.

FIG. 10 is a timing chart showing a relationship between an operating state of liquid crystal shutters and a display state of left-eye and right-eye images on a liquid crystal display device according to a conventional technology.

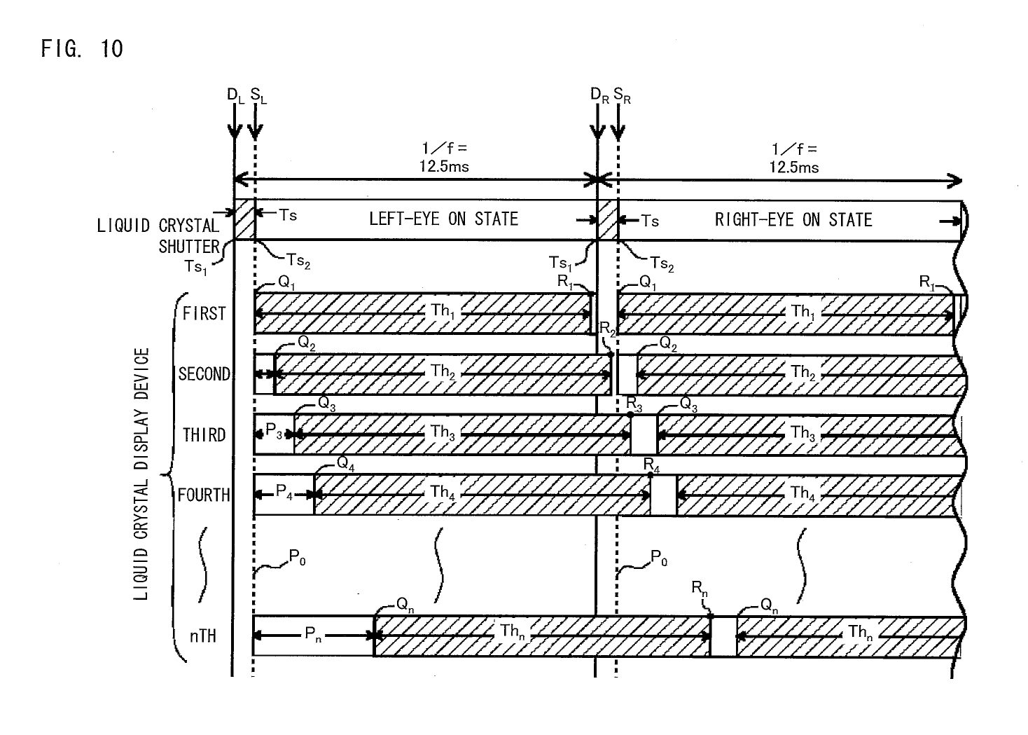

FIG. 11 is a timing chart showing a relationship between an operating state of liquid crystal shutters and a display state of left-eye and right-eye images on a liquid crystal display device according to another conventional technology.

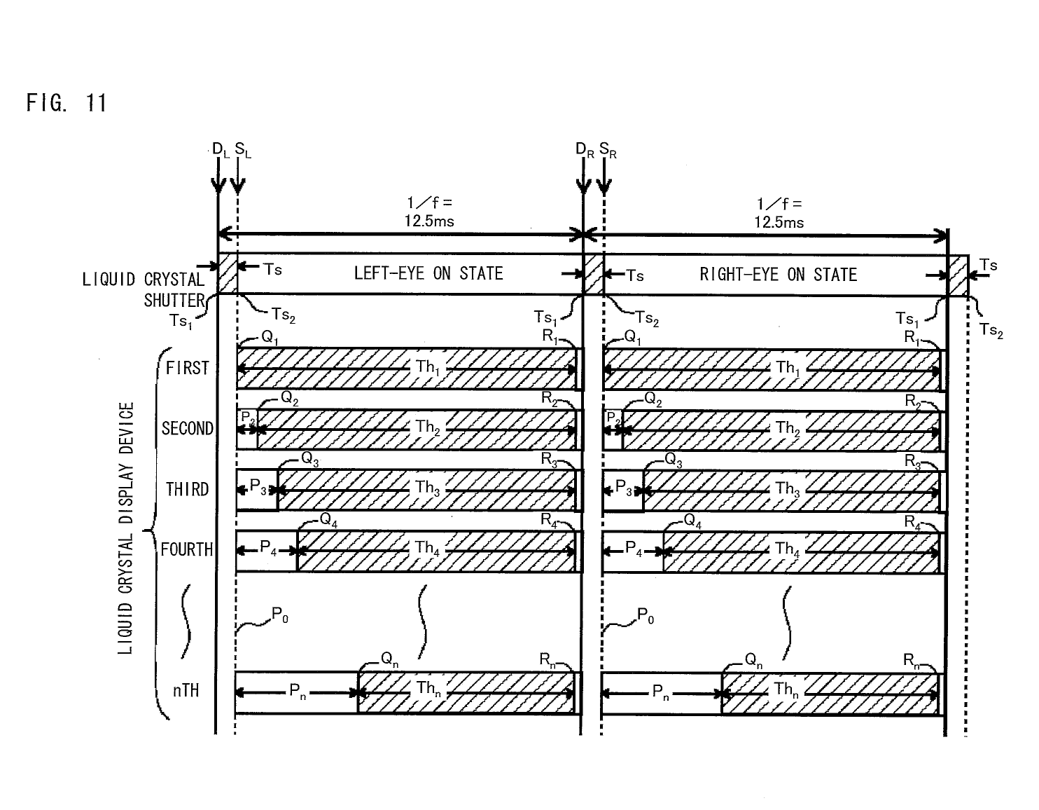

FIG. 12 is a diagram showing the case of a ball moving from an upper left portion to a lower left portion in a single frame period.

FIG. 13 is a diagram showing left-eye and right-eye images that are supplied to a conventional stereoscopic image display device in the case of FIG. 12.

### DESCRIPTION OF EMBODIMENTS

In the following, an embodiment of the present invention is described in detail with reference to the drawings. It should be noted, however, that the size of, the material for, the shape of, and the relative configuration of components described in the embodiment, for example, are merely an embodiment and the scope of the present invention should not be narrowly interpreted thereby.

### Embodiment 1

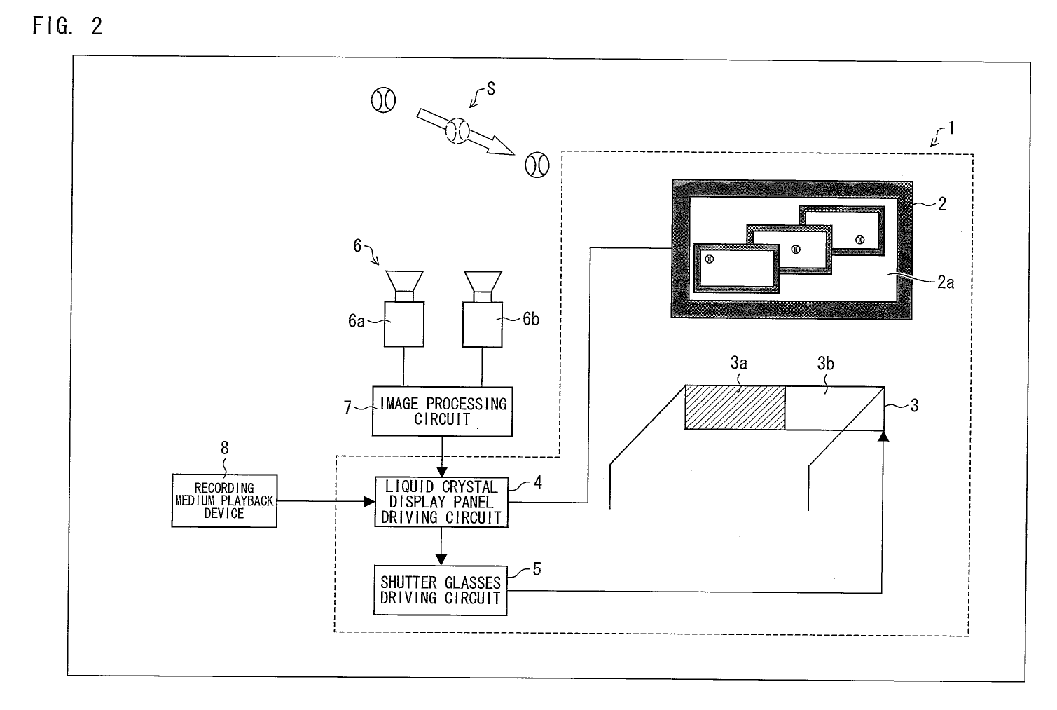

A configuration of a stereoscopic image display device 1 of the present invention is schematically described below with reference to FIG. 2.

As shown in FIG. 2, the stereoscopic image display device 1 includes a liquid crystal panel 2 (display section) and shutter glasses 3 (light intensity adjusting section).

The stereoscopic image display device 1 further includes: a liquid crystal display panel driving circuit 4, which drives the liquid crystal display panel 2; and a shutter glasses driving circuit 5, which drives the shutter glasses 3.

The liquid crystal display panel driving circuit 4 receives, via an image processing circuit 7, image data for a subject S as acquired, for example, by using a stereoscopic camera 6 (stereoscopic image pickup device).

The stereoscopic camera 6 includes a left-eye camera 6a (first image data pickup section) and a right-eye camera 6b (second image data pickup section), and the left-eye camera 6a and the right-eye camera 6b are provided approximately 6.5 cm (predetermined distance) apart from each other so as to be able to acquire left-eye and right-eye images with binocular parallax.

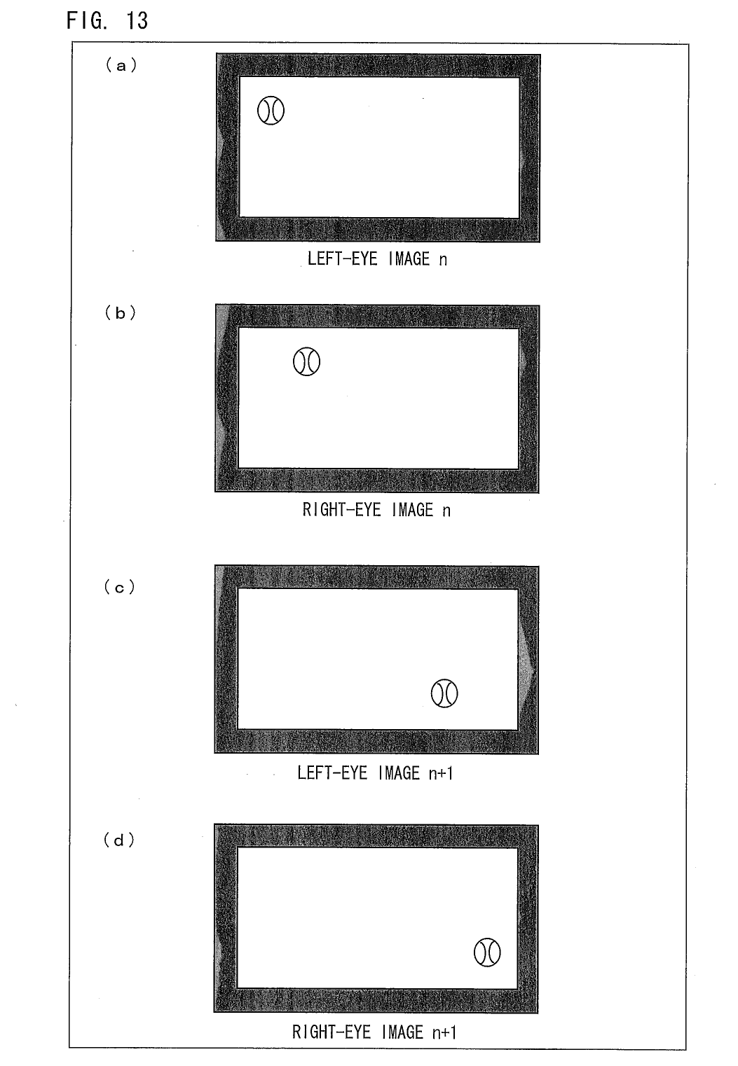

Therefore, left-eye and right-eye images acquired by the stereoscopic camera 6 are images having a slight difference in horizontal position from each other (the left-eye and right-eye images each being an image taken from a different point of view from the other) as shown in (a) and (b) of FIG. 13 or in (c) and (d) of FIG. 13, and showing such left-eye and right-eye images to the left and right eyes of a viewer alternately causes the viewer to feel a sense of stereoscopic vision as if the resulting image were in the back of the display surface 2a of the liquid crystal display panel 2 or popped up from the display surface 2a of the liquid crystal display panel 2.

The image processing circuit 7 supplies, to the liquid crystal display panel driving circuit 4, image data obtained by rearranging left-eye images n, n+1, . . . and right-eye images n+½, n+ 3/2, . . . as continuously acquired by the stereoscopic camera 6, for example, in the following order: the left-eye image n, the right-eye image n+½, the left-eye image n+1, the right-eye image n+ 3/2, . . . .

Although not illustrated, the image processing circuit 7 may include a frame memory in which the left-eye image n, the right-eye image n+½, the left-eye image n+1, the right-eye image n+ 3/2, . . . are stored in order and from which the left-eye image n, the right-eye image n+½, the left-eye image n+1, the right-eye image n+ 3/2, . . . are outputted in this order to the liquid crystal panel driving circuit 4.

Then, the liquid crystal panel driving circuit 4 causes the left-eye image n, the right-eye image n+½, the left-eye image n+1, the right-eye image n+ 3/2, . . . to be displayed in sequence on the display surface 2a of the liquid crystal display panel 2, for example, every ½ frame period (1/f=8.35 ms, f: drive frequency=120 Hz).

Further, the liquid crystal panel driving circuit 4 sends, to the shutter glasses driving circuit 5, a clock signal used in causing the left-eye image n, the right-eye image n+½, the left-eye image n+1, the right-eye image n+ 3/2, . . . to be displayed in sequence, and the shutter glasses driving circuit 5 adjusts, in synchronization with the clock signal, the amount of transmission of the amount of light emitted from the display surface 2a of the liquid crystal display panel 2 in a left-eye part 3a of the shutter glasses 3 and in a right-eye part of 3b of the shutter glasses 3.

That is, when the left-eye images n, n+1, . . . are displayed on the display surface 2a of the liquid crystal display panel 2, the right-eye part 3b of the shutter glasses 3 is in a light blocking or scattering state and the left-eye part 3a of the shutter glasses 3 is in a light transmitting state, so that a viewer who looks at the stereoscopic image display device 1 can see the left-eye images n, n+1, . . . with his/her left eye alone.

Meanwhile, when the right-eye images n+½, n+ 3/2, . . . are displayed on the display surface 2a of the liquid crystal display panel 2, the left-eye part 3a of the shutter glasses 3 is in a light blocking or scattering state and the right-eye part 3b of the shutter glasses 3 is in a light transmitting state, so that a viewer who looks at the stereoscopic image display device 1 can see the right-eye images n+½, n+ 3/2, . . . with his/her right eye alone.

Such a configuration allows the viewer to view the left-eye images n, n+1, . . . with his/her left eye alone when the left-eye images n, n+1, . . . are displayed on the display surface 2a of the liquid crystal display panel 2, and to view the right-eye images n+½, n+ 3/2, . . . with his/her right eye alone when the right-eye images n+½, n+ 3/2, . . . are displayed on the display surface 2a of the liquid crystal display panel 2.

Conventionally, since no attention has been paid to the fact that in a case where the left-eye images n, n+1, . . . and the right-eye images n, n+1, . . . are alternately displayed in a constant cycle, there occurs a difference in time between a point in time at which to see the left-eye images n, n+1, . . . with the left eye and a point in time at which to see the right-eye images n, n+1, . . . with the right eye, the left-eye camera 6a of the stereoscopic camera 6 and the right-eye camera 6b of the stereoscopic camera 6 have been set to acquire the left-eye images n, n+1, . . . and the right-eye images n, n+1, . . . at the same timings.

Therefore, the conventional configuration has been such that the left-eye camera 6a of the stereoscopic camera 6 and the right-eye camera 6b of the stereoscopic camera 6 acquire the left-eye images n, n+1, . . . and the right-eye images n, n+1, . . . , for example, at intervals of a single frame period (1/f=16.7 ms, f: drive frequency=60 Hz), so that the left-eye image n, the right-eye image n, the left-eye image n+1, the right-eye image n+1, . . . are displayed in sequence on the display surface 2a of the liquid crystal display panel 2 every ½ frame period (1/f=8.35 ms, f: drive frequency=120 Hz).

Consequently, the left-eye images n and n+1 and the right-eye images n and n+1, which are acquired by the stereoscopic camera 6, become such images as those shown in FIG. 13, and no change in image due to the difference in time can be reflected at all.

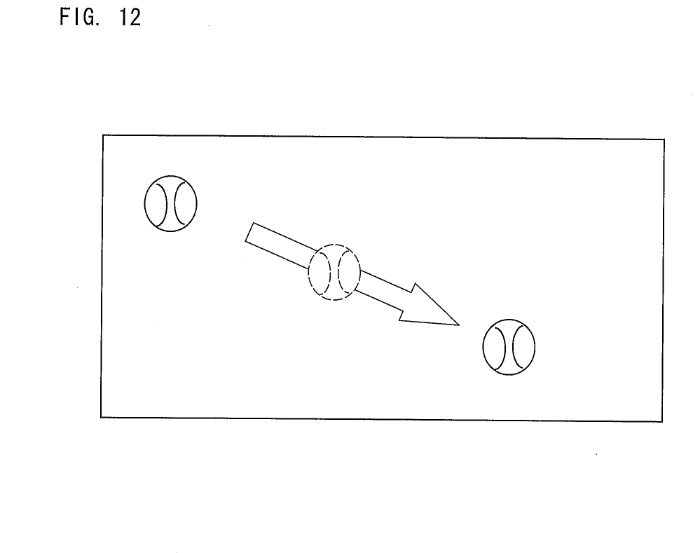

That is, in the case of a ball moving from an upper left portion to a lower left portion in a single frame period, as shown in FIG. 12, the position of the ball after a ½ frame period is in a substantially central portion of FIG. 12 as indicated by a dotted line. However, in the conventional configuration, such an image has not been acquired by the stereoscopic camera 6.

Such an image can be acquired by shortening intervals at which images are acquired by the stereoscopic camera 6. In such a case, however, it is necessary to further increase the drive frequency at which to display left-eye and right-eye images on the display surface 2a of the liquid crystal display panel 2, which causes a problem.

Meanwhile, in the stereoscopic image display device 1 of the present embodiment, image data that is supplied to the liquid crystal display panel driving circuit 4 via the image processing circuit 7 is such that either a left-eye or a right-eye image is image data acquired between a timing at which an image in the current frame of the other image was acquired and a timing at which an image in the next frame of the other image was acquired.

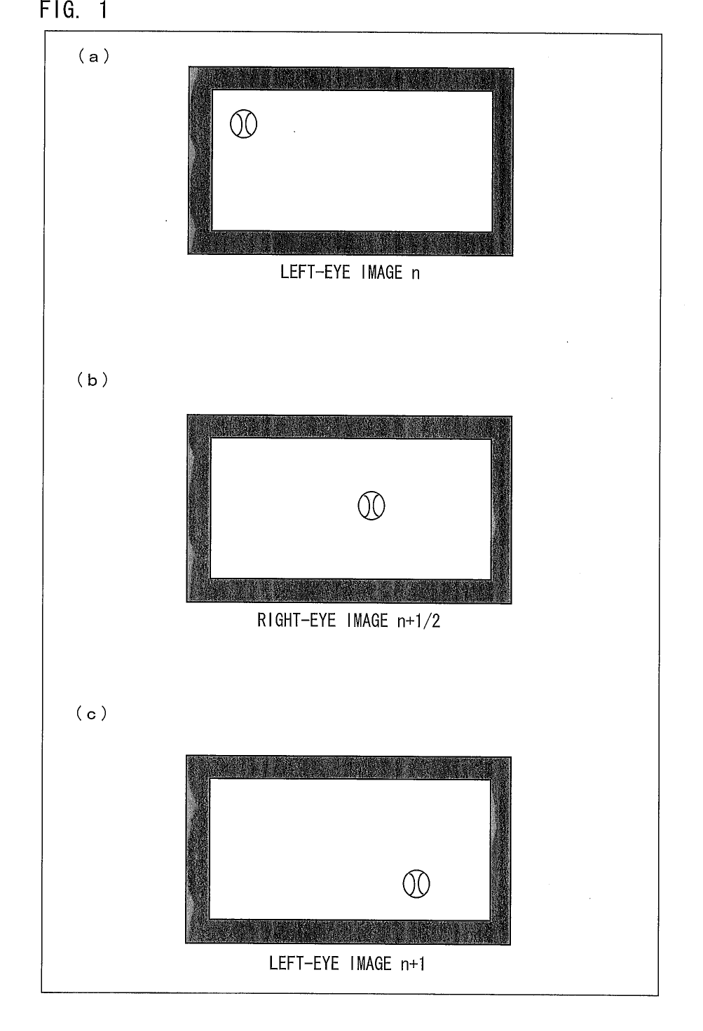

FIG. 1 is a diagram showing left-eye and right-eye images that are supplied to the liquid crystal display panel driving circuit 4 of the stereoscopic image display device 1.

As shown in FIG. 1, the left-eye and right-eye images that are supplied to the liquid crystal display panel driving circuit 4 of the stereoscopic image display device 1 are such that the right-eye image n+½ ((b) of FIG. 1) is image data acquired between a timing at which an image in the current frame of left-eye image (left-eye image n shown in (a) of FIG. 1) was acquired and a timing at which an image in the next frame of left-eye image (left-eye image n+1 shown in (c) of FIG. 1) was acquired.

In the present embodiment, the right-eye camera 6b of the stereoscopic camera 6 acquires image data (right-eye image n+½ shown in (b) of FIG. 1) at a timing just between a timing at which the left-eye camera 6a of the stereoscopic camera 6 acquires image data in the current frame (left-eye image n shown in (a) of FIG. 1) and a timing at which the left-eye camera 6a of the stereoscopic camera 6 acquires image data in the next frame (left-eye image n+1 shown in (c) of FIG. 1).

The image (right-eye image n+½ shown in (b) of FIG. 1) can be suitably used as an interpolating image (image in an intermediate frame) that interpolates between the image in the current frame (left-eye image n shown in (a) of FIG. 1) and the image in the next frame (left-eye image n+1 shown in (c) of FIG. 1).

In the present embodiment, the right-eye camera 6b of the stereoscopic camera 6 acquires the right-eye images n+½, n+ 3/2, . . . at timings a ½ frame period behind timings at which the left-eye camera 6a of the stereoscopic camera 6 acquires the left-eye images n, n+1, . . . . However, this does not imply any limitation. The left-eye camera 6a of the stereoscopic camera 6 may acquire left-eye images at timings a ½ frame period behind timings at which the right-eye camera 6b of the stereoscopic camera 6 acquires right-eye images.

Further, the time lag between a timing at which the left-eye camera 6a of the stereoscopic camera 6 acquires a left-eye image and the timing at which the right-eye camera 6b of the stereoscopic camera 6 acquires a right-eye image is not limited to a ½ frame period, as long as the left-eye and right-eye images are not acquired simultaneously.

The foregoing configuration is a configuration in which the right-eye image n+½ ((b) of FIG. 1), which is an interpolating image, is displayed between a display of an image in the current frame of left-eye image (left-eye image n shown in (a) of FIG. 1) and a display of an image in the next frame of left-eye image (left-eye image n+1 shown in (c) of FIG. 1). Therefore, the foregoing configuration makes it possible to achieve a stereoscopic image display device 1 capable of carrying out a stereoscopic display with improved display quality of moving images and improved viewability of moving images.

The present embodiment is configured such that images are acquired by the stereoscopic camera 6 at intervals of a single frame period (1/f=16.7 ms, f: drive frequency=60 Hz), and the left-eye images n, n+1, . . . thus obtained and the right-eye images n+½, n+ 3/2, . . . thus obtained are displayed in sequence on the display surface 2a of the liquid crystal display panel 2 every ½ frame period (1/f=8.35 ms, f: drive frequency=120 Hz). However, this does not imply any limitation. The intervals at which images are acquired by the stereoscopic camera 6 and the drive frequency at which the left-eye images n, n+1, . . . and the right-eye images n+½, n+ 3/2, . . . are displayed on the display surface 2a of the liquid crystal display panel 2 can be appropriately set.

Since the present embodiment is configured to use the liquid crystal display panel 2, it is preferable that a liquid crystal material fast in response speed be used to effectively prevent a ghost image from occurring due to a problem with response time peculiar to liquid crystals. Further, it is preferable that the finish time of the hold period for the bottom-of-the-row scanning line, where scanning finishes, is matched with the start time of switching between the left-eye part 3a of the shutter glasses 3 and the right-eye part 3b of the shutter glasses 3 or set to lead the start time.

In the present embodiment, the liquid crystal display panel 2 is used as the display section of the stereoscopic image display device 1. However, this does not imply any limitation. For example, a PDP, a CRT, an organic EL display device (display panel including an organic light-emitting layer), or the like can be used.

Especially in a case where an organic EL display device is used as the display section of the stereoscopic image display device 1, a problem with a ghost can be prevented from occurring due to a problem with response speed peculiar to liquid crystals, and a stereoscopic image display device 1 including a thin display section can be achieved.

Further, in the present embodiment, a polymer-dispersed liquid crystal element (light-scattering liquid crystal element) is used as the light intensity adjusting section, which is the shutter glasses 3.

When a voltage is applied to a polymer-dispersed liquid crystal layer of the polymer-dispersed liquid crystal element, the polymer-dispersed liquid crystal layer transmits light; on the other hand, when no voltage is applied to the polymer-dispersed liquid crystal layer, the polymer-dispersed liquid crystal layer scatters light.

The left-eye and right-eye parts 3a and 3b of the shutter glasses 3 are each provided with a polymer-dispersed liquid crystal element, and predetermined voltages are applied to the respective polymer-dispersed liquid crystal elements alternately in synchronization with the constant cycle in which the left-eye images n, n+1, . . . and the right-eye images n+½, n+ 3/2, . . . are alternately displayed on the display surface 2a of the liquid crystal display panel 2.

That is, when the left-eye images n, n+1, . . . are displayed on the display surface 2a of the liquid crystal display panel 2, the right-eye part 3b of the shutter glasses 3 is in a light scattering state and the left-eye part 3a of the shutter glasses 3 is in a light transmitting state, so that a viewer who looks at the stereoscopic image display device 1 can see the left-eye images n, n+1, . . . with his/her left eye alone.

Meanwhile, when the right-eye images n+½, n+ 3/2, . . . are displayed on the display surface 2a of the liquid crystal display panel 2, the left-eye part 3a of the shutter glasses 3 is in a light scattering state and the right-eye part 3b of the shutter glasses 3 is in a light transmitting state, so that a viewer who looks at the stereoscopic image display device 1 can see the right-eye images n+½, n+ 3/2, . . . with his/her right eye alone.

By using, as the light intensity adjusting section, which is the shutter glasses 3, a light-scattering liquid crystal element that transmits or scatters light, the foregoing configuration can significantly improve transmittance during transmission as compared with the case of use of a liquid crystal shutter including a polarizer and utilizing polarization, thus making it possible to achieve a stereoscopic image display device 1 with increased brightness.

According to the configuration thus far described, the left-eye images n, n+1, . . . and the right-eye images n+½, n+ 3/2, . . . of the subject S as acquired, for example, by using the stereoscopic camera 6 are supplied to the liquid crystal display panel driving circuit 4 via the image processing circuit 7. However, this does not imply any limitation. As shown in FIG. 2, such a configuration is possible in which the left-eye images n, n+1, . . . and the right-eye images n+½, n+ 3/2, . . . are supplied to the liquid crystal display panel driving circuit 4 from the recording medium playback device 8 playing back a recording medium in which the left-eye image n, the right-eye image n+½, the left-eye image n+1, the right-eye image n+ 3/2, . . . have been stored in sequence.

Examples of the recording medium include, but are not limited to, blue-ray discs, DVDs, etc., and examples of the recording medium playback device 8 include, but are not limited to, blue-ray disc players, DVD players, etc.

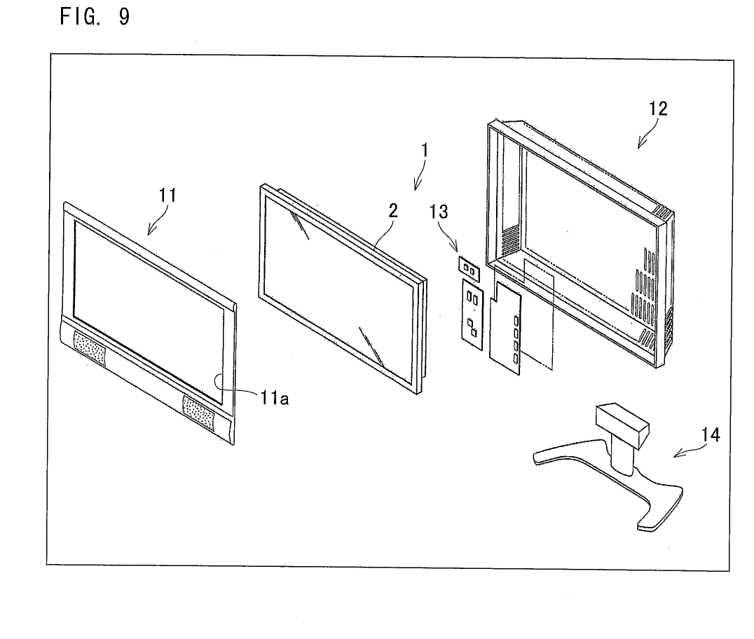

FIG. 9 is a diagram showing an example of a television receiver including such a stereoscopic image display device 1 including a liquid crystal display panel 2.

The television receiver includes: a stereoscopic image display device 1, which includes a liquid crystal display panel 2; a tuner section; a speaker section; and a power supply section. The stereoscopic image display device 1, the tuner section, the speaker section, and the power supply section are sandwiched between a first housing 11 and a second housing 12.

As shown in FIG. 9, the first housing 11 is provided with an opening 11a through which an image displayed on the liquid crystal display panel 2 is transmitted. Meanwhile, the second housing 12 covers the back of the liquid crystal display panel 2. The liquid crystal display panel driving circuit 4 for driving the liquid crystal display panel 2 and the power supply section are provided on a circuit substrate 13. Attached to the lower side of the second housing 12 is a supporting member 14.

The tuner section for example receives a television broadcast and outputs an image signal to the liquid crystal display panel driving circuit 4 shown in FIG. 2, and the liquid crystal display panel driving circuit 4 causes the left-eye image n, the right-eye image n+½, the left-eye image n+1, the right-eye image n+ 3/2, . . . to be displayed in sequence on the display surface 2a of the liquid crystal display panel 2, for example, every ½ frame period (1/f=8.35 ms, f: drive frequency=120 Hz).

That is, a method for transmitting the television broadcast (stereoscopic image transmitting method) is a method for transmitting data for the left-eye image and data for the right-eye image, in which either of the left-eye and right-eye images is an image that interpolates between an image in the current frame of the other image and an image in the next frame of the other image.

The transmitting method is applicable not only to television broadcasts but also, for example, data for images that are transmitted via Internet lines.

As described above, the television receiver includes a stereoscopic image display device 1. This makes it possible to achieve a television receiver capable of carrying out a stereoscopic display with improved display quality of moving images and improved viewability of moving images.

Although not illustrated, the aforementioned stereoscopic image display device 1 is also applicable to the field of game apparatuses.

Such a game apparatus including a stereoscopic image display device 1 makes it possible to achieve a game apparatus capable of carrying out a stereoscopic display with improved display quality of moving images and improved viewability of moving images.

Examples of the game apparatus include, but are not limited to, 3D game machines (game machines capable of displaying stereoscopic images), 3D karaoke, etc.

### Embodiment 2

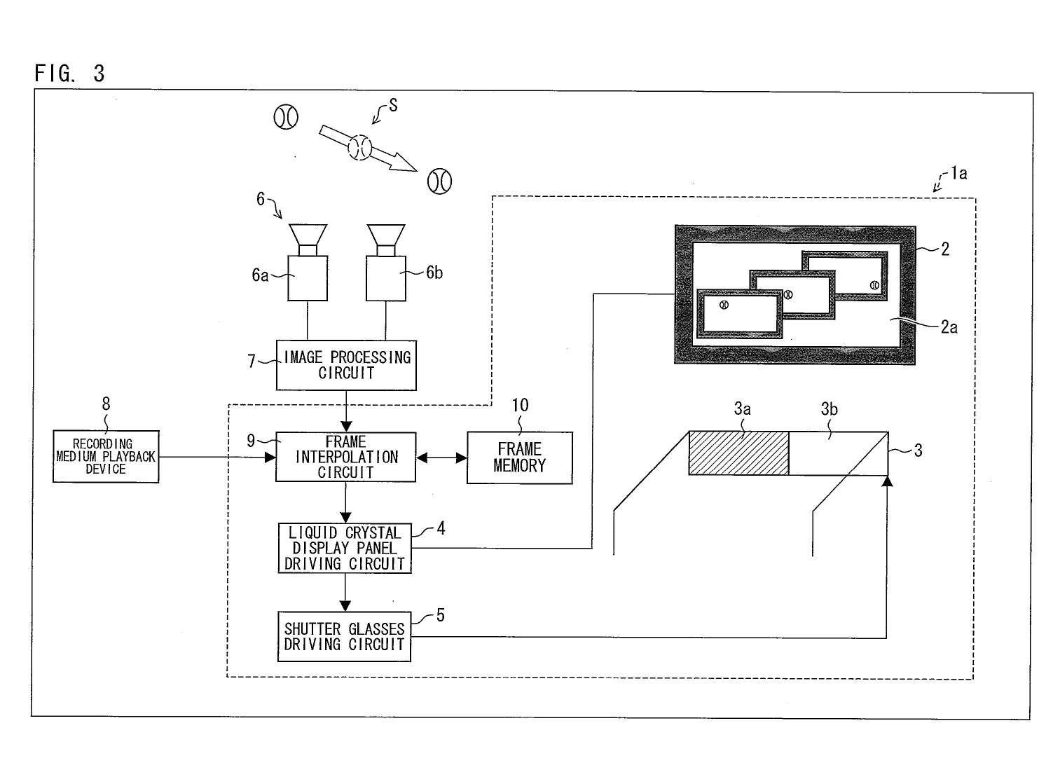

A second embodiment of the present invention is described below with reference to FIGS. 3 through 5. The present embodiment differs from Embodiment 1 in that a stereoscopic image display device includes, for example, a frame interpolation circuit 9 (image generating circuit) which generates a left-eye image n+½by predicting an image between a left-eye image n and a left-eye image n+1 from the left-eye images n and n+1. The other components are as described in Embodiment 1. For convenience of explanation, those members which have the same functions as those shown in the drawings of Embodiment 1 are given the same reference signs, and as such, are not described below.

FIG. 3 is a diagram schematically showing a configuration of a stereoscopic image display device 1a according to the present embodiment.

The present embodiment assumes that the left-eye camera 6a of the stereoscopic camera 6 and the right-eye camera 6b of the stereoscopic camera 6 are set to acquire the left-eye images n, n+1, . . . and the right-eye images n, n+1, . . . at the same timings, as has been done conventionally, that the left-eye images n, n+1, . . . and the right-eye images n, n+1, . . . are supplied from the image processing circuit 7 to the frame interpolation circuit 9 of the stereoscopic image display device 1a, and that image data that is supplied from the recording medium playback device 8 to the frame interpolation circuit 9 is conventional image data (image data obtained by rearranging the left-eye images n, n+1, . . . and the right-eye images n, n+1, . . . in the following order: the left-eye image n, the right-eye image n, the left-eye image n+1, the right-eye image n+1, . . . ).

As shown in FIG. 3, the aforementioned conventional image data are sent in sequence from the image processing circuit 7 to the frame interpolation circuit 9 of the stereoscopic image display device 1a. Further, the stereoscopic image display device 1a includes a frame memory 10 in which at least one frame of image data can be stored.

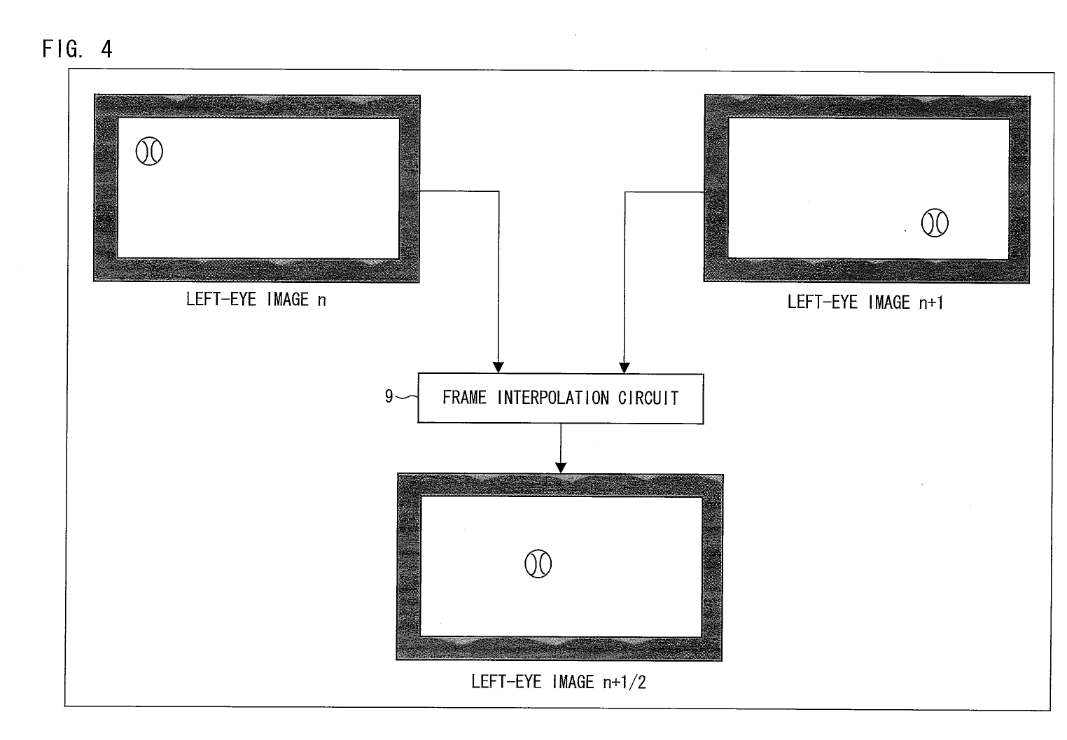

FIG. 4 is a diagram showing a function of the frame interpolation circuit 9 of the stereoscopic image display device 1a.

As shown in FIG. 4, the frame interpolation circuit 9 stores, in the frame memory 10, the left-eye image n sent from the image processing circuit 7 before the left-eye image n+1, and generates the left-eye image n+½ by predicting, in accordance with (i) the left-eye image n+1 sent from the image processing circuit 7 after the left-eye image n and (ii) the left-eye image n read out from the frame memory 10, an image between the left-eye image n and the left-eye image n+1.

The frame interpolation circuit 9 extracts a motion vector associated with the subject S (ball) from the left-eye images n and n+1, and generates the left-eye image n+½ in accordance with the motion vector and the period of time elapsed since the point in time at which the left-eye image n was acquired (setting time for an image to be generated; in the present embodiment, ½ frame period).

That is, the frame interpolation circuit 9 first stores, in the frame memory 10, the left-eye image n sent from the image processing circuit 7 before the left-eye image n+1, supplies the liquid crystal display panel driving circuit 4 with the right-eye image n sent from the image processing circuit 7 after the left-eye image n, generates the left-eye image n+½ by predicting, in accordance with (i) the left-eye image n+1 sent from the image processing circuit 7 after the right-eye image n and (ii) the left-eye image n read out from the frame memory 10, an image between the left-eye image n and the left-eye image n+1, supplies the left-eye image n+½ to the liquid crystal display panel driving circuit 4, and supplies the liquid crystal display panel driving circuit 4 with the right-eye image n+1 sent from the image processing circuit 7 after the left-eye image n+1.

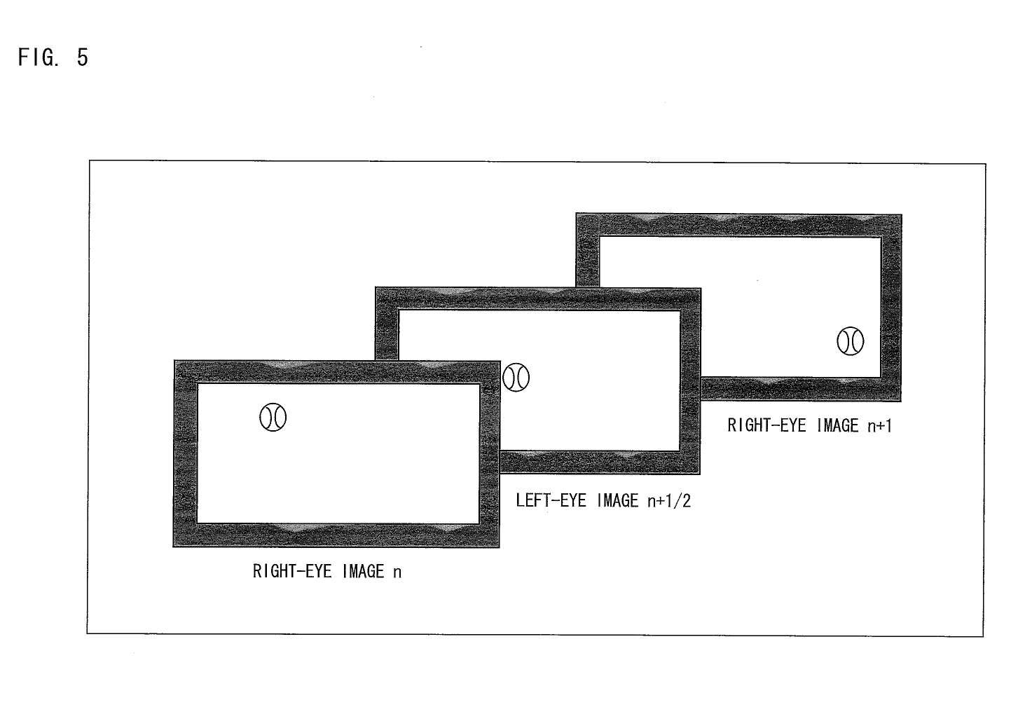

FIG. 5 is a diagram showing left-eye and right-eye images that are displayed on the stereoscopic image display device 1a.

As shown in FIG. 5, the right-eye image n sent from the image processing circuit 7 before the right-eye image n+1, the left-eye image n+½ generated by the frame interpolation circuit 9, the right-eye image n+1 sent from the image processing circuit 7 after the right-eye image n are displayed in sequence on the display surface 2a of the liquid crystal display panel 2 of the stereoscopic image display device 1a.

The foregoing configuration makes it possible to achieve a stereoscopic image display device 1a capable of carrying out a stereoscopic display with improved display quality of moving images and improved viewability of moving images even when left-eye and right-eye images acquired at the same timing are inputted to the stereoscopic image display device 1a.

The present embodiment has been described by taking, as an example, a case where as shown in FIG. 4, the frame interpolation circuit 9 generates a left-eye image n+½ by predicting an image between a left-eye image n and a left-eye image n+1 in accordance with the left-eye images n and n+1. However, this does not imply any limitation. The frame interpolation circuit 9 may generate a right-eye image n+½ by predicting an image between a right-eye image n and a right-eye image n+1 in accordance with the right-eye images n and n+1.

### Embodiment 3

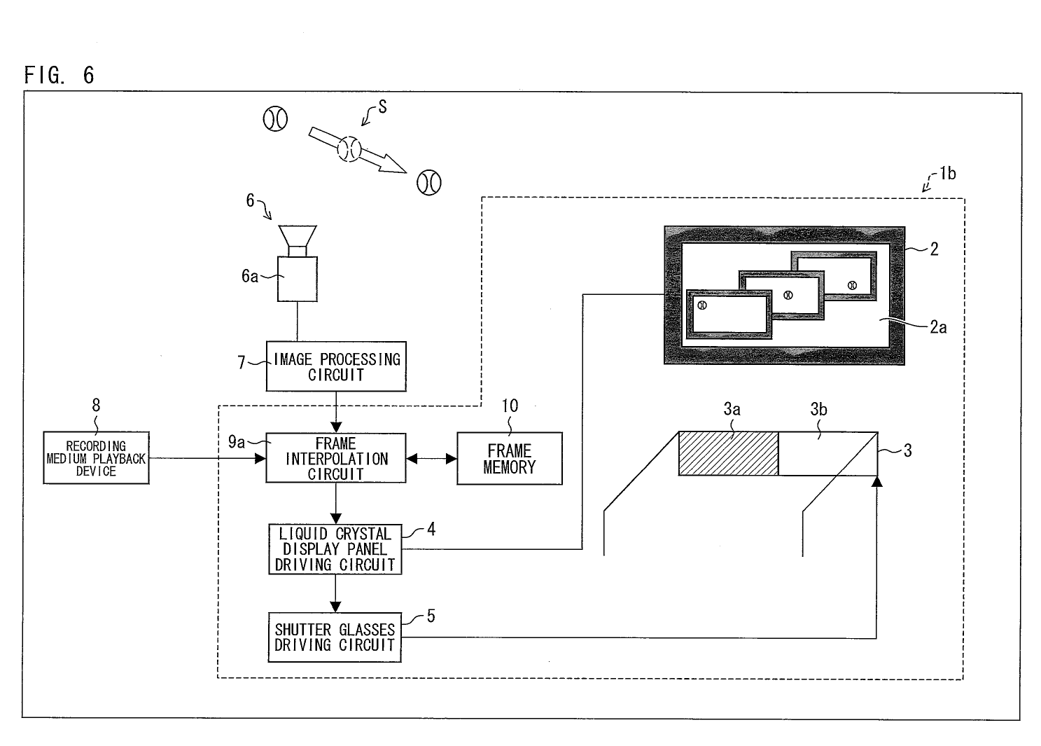

A third embodiment of the present invention is described below with reference to FIGS. 6 through 8. The present embodiment differs from Embodiments 1 and 2 in that a stereoscopic image display device includes a frame interpolation circuit 9a (image generating circuit) which generates a right-eye image n+½ by predicting an image between a left-eye image n and a left-eye image n+1 from the left-eye images n and n+1. The other components are as described in Embodiments 1 and 2. For convenience of explanation, those members which have the same functions as those shown in the drawings of Embodiment 1 are given the same reference signs, and as such, are not described below.

FIG. 6 is a diagram schematically showing a configuration of a stereoscopic image display device lb according to the present embodiment.

The present embodiment assumes that only image data acquired by either of the left-eye and right-eye cameras 6a and 6b of the stereoscopic camera 6 is supplied from the image processing circuit 7 to the frame interpolation circuit 9a of the stereoscopic image display device lb and that image data that is supplied from the recording medium playback device 8 to the frame interpolation circuit 9a is the same image data as that described above.

In the present embodiment, as shown in FIG. 6, only the left-eye images n, n+1, . . . acquired by the left-eye camera 6a of the stereoscopic camera 6 are sent in sequence from the image processing circuit 7 to the frame interpolation circuit 9a of the stereoscopic image display device 1b.

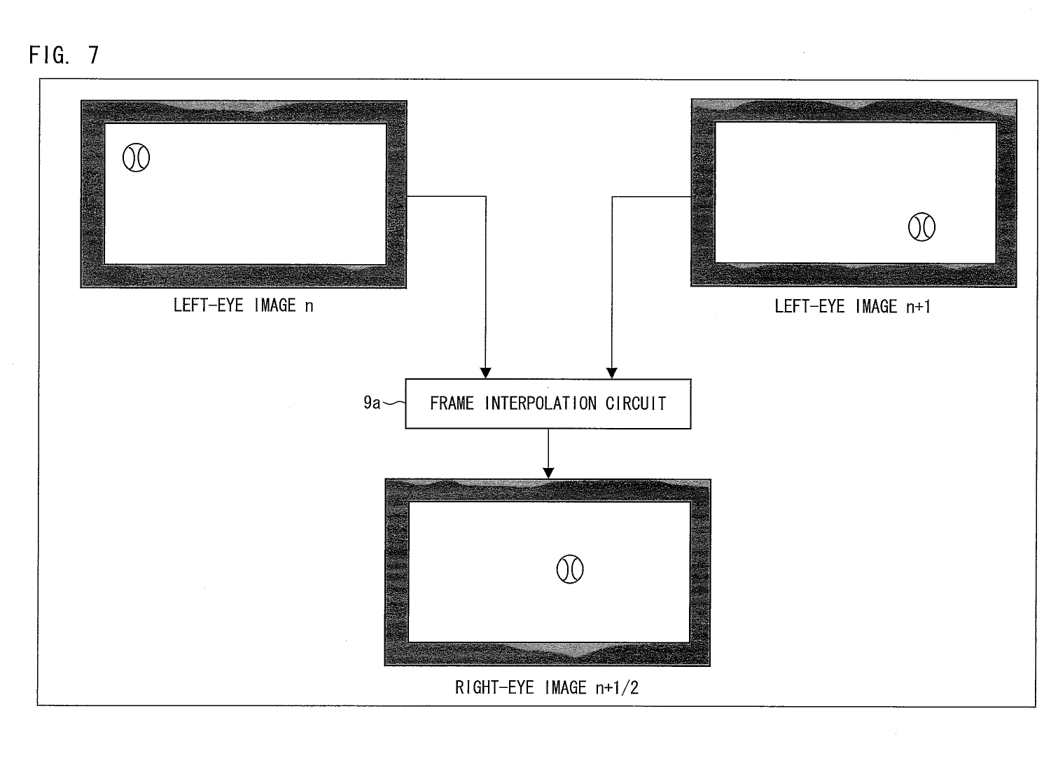

FIG. 7 is a diagram showing a function of the frame interpolation circuit 9a of the stereoscopic image display device 1b.

As shown in FIG. 7, the frame interpolation circuit 9a stores, in the frame memory 10, the left-eye image n sent from the image processing circuit 7 before the left-eye image n+1, generates the left-eye image n+½ by predicting, in accordance with (i) the left-eye image n+1 sent from the image processing circuit 7 after the left-eye image n and (ii) the left-eye image n read out from the frame memory 10, an image between the left-eye image n and the left-eye image n+1, and then generates the right-eye image n+½ by performing such image processing that the subject S (ball) in the left-eye image n+½ thus generated is symmetrically displaced in a horizontal direction.

That is, the frame interpolation circuit 9a first stores, in the frame memory 10, the left-eye image n sent from the image processing circuit 7 before the left-eye image n+1, generates the left-eye image n+½ by predicting, in accordance with (i) the left-eye image n+1 sent from the image processing circuit 7 after the left-eye image n and (ii) the left-eye image n read out from the frame memory 10, an image between the left-eye image n and the left-eye image n+1, generates the right-eye image n+½ by performing such image processing that a symmetrical displacement is made in a horizontal direction, and then supplies the right-eye image n+½ to the liquid crystal display panel driving circuit 4. It should be noted that the left-eye image n is both read out from the frame memory 10 and supplied to the liquid crystal panel driving circuit 4. Then, the left-eye image n+1 is stored in the frame memory 10, and when a left-eye image n+2 is sent from the image processing circuit 7, the left-eye image n+1 is both read out from the frame memory 10 and supplied to the liquid crystal panel driving circuit 4.

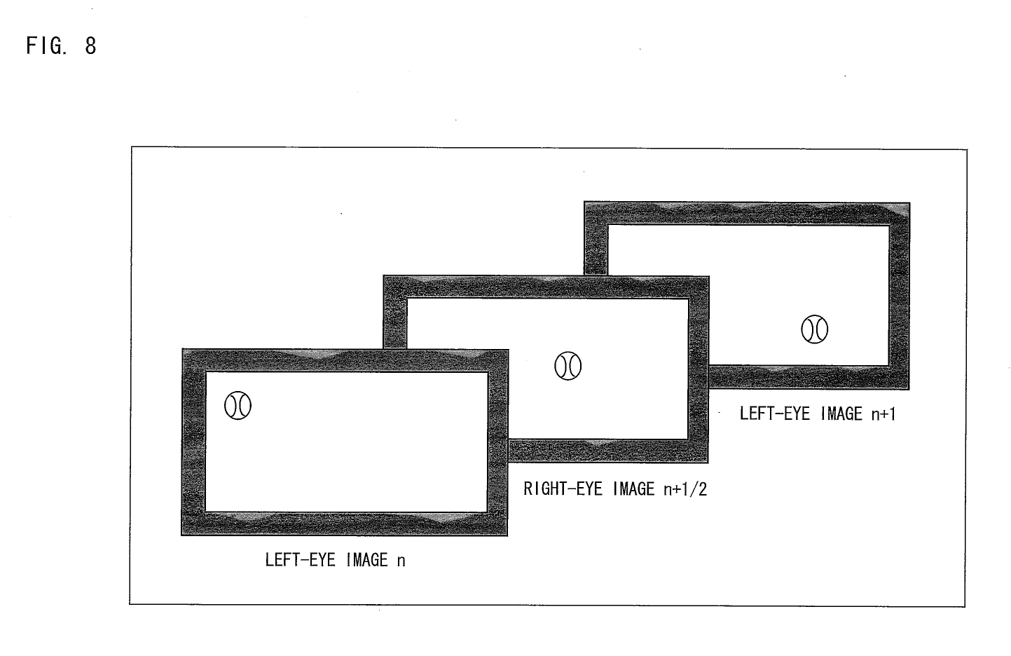

FIG. 8 is a diagram showing left-eye and right-eye images that are displayed on the stereoscopic image display device 1b.

As shown in FIG. 8, the left-eye image n, the right-eye image n+½ generated by the frame interpolation circuit 9a, and the left-eye image n+1 are displayed in sequence on the display surface 2a of the liquid crystal display panel 2 of the stereoscopic image display device 1b.

The foregoing configuration makes it possible to achieve a stereoscopic image display device lb capable of carrying out a stereoscopic display with improved display quality of moving images and improved viewability of moving images, for example, even when only left-eye images are inputted to the stereoscopic image display device 1b.

The present embodiment has been described by taking, as an example, a case where as shown in FIG. 7, the frame interpolation circuit 9a generates a left-eye image n+½ by predicting an image between a left-eye image n and a left-eye image n+1 in accordance with the left-eye images n and n+1 and generates a right-eye image n+½ by performing such image processing that a symmetrical displacement is made in a horizontal direction. However, this does not imply any limitation. The frame interpolation circuit 9a may generate a right-eye image n+½ by predicting an image between a right-eye image n and a right-eye image n+1 in accordance with the right-eye images n and n+1 and generates a left-eye image n+½ by performing such image processing that a symmetrical displacement is made in a horizontal direction.

The stereoscopic image display device of the present invention is preferably configured to further include an image generating circuit which generates either of the left-eye and right-eye images by predicting, in accordance with an image in the current frame and an image in the next frame of the other image as taken from the different point of view, an image between the image in the current frame and the image in the next frame as taken from the different point of view.

The stereoscopic image display device includes, for example, an image generating circuit which predicts, in accordance with an image in the current frame and an image in the next frame of the other image (right-eye image) as taken from the different point of view, i.e., an image in the Nth frame (current frame) of the left-eye image and an image in the N+1th frame (next frame) of the left-eye image, an image between the image in the Nth frame and the image in the N+1th frame (e.g., an image in the N+½ frame), and which generates the image in the N+½ frame.

Therefore, even when left-eye and right-eye images acquired at the same timing are inputted to the stereoscopic image display device, the image generating circuit can generate an image that interpolates between the image in the Nth frame of the left-eye image and the image in the N+1th frame of the left-eye image (e.g., an image in the N+½th frame).

The foregoing configuration makes it possible to achieve a stereoscopic image display device capable of carrying out a stereoscopic display with improved display quality of moving images and improved viewability of moving images even when left-eye and right-eye images acquired at the same timing are inputted to the stereoscopic image display device.

The stereoscopic image display device of the present invention is preferably configured to further include an image generating circuit which generates either of the left-eye and right-eye images by predicting, in accordance with an image in the current frame of the other image and an image in the next frame of the other image, an image between the image in the current frame of the other image and the image in the next frame of the other image.

The stereoscopic image display device includes, for example, an image generating circuit which, by predicting, in accordance with an image in the Nth frame (current frame) of the left-eye image and an image in the N+1 th frame (next frame) of the left-eye image, an image between the image in the Nth frame and the image in the N+1th frame (e.g., an image in the N+½th frame), generates an image in the N+½th frame of the right-eye image from the image in the N+½th frame of the left-eye image.

Therefore, even when only left-eye images are inputted to the stereoscopic image display device, the image generating circuit can generate an image in the N+½ the frame of a right-eye image from an image that interpolates between an image in the Nth frame of the left-eye image and an image in the N+1th frame of the left-eye image (e.g., from an image in the N+½th frame).

The foregoing configuration makes it possible to achieve a stereoscopic image display device capable of carrying out a stereoscopic display with improved display quality of moving images and improved viewability of moving images, for example, even when only left-eye images are inputted to the stereoscopic image display device.

The stereoscopic image display device of the present invention is preferably configured such that either of the left-eye and right-eye images is an image acquired between a timing at which the image in the current frame of the other image was acquired and a timing at which the image in the next frame of the other image was acquired.

In the stereoscopic image display device, the right-eye image, for example, is an image acquired between a timing at which the image in the Nth frame (current frame) of the left-eye image was acquired and a timing at which the image in the N+1th frame (current frame) of the left-eye image was acquired. For example, the right-eye image is an image in the N+½th frame.

According to the foregoing configuration, either of the left-eye and right-eye images is an image acquired between a timing at which the image in the current frame of the other image was acquired and a timing at which the image in the next frame of the other image was acquired. This makes it unnecessary to provide the stereoscopic image display device with a separate image generating circuit for generating an interpolating image, and therefore makes it possible to carry out a stereoscopic display more easily and more inexpensively with improved display quality of moving images and improved viewability of moving images.

The stereoscopic image display device of the present invention is preferably configured such that the image generating circuit generates an image in an intermediate frame that is between the current frame and the next frame.

According to the foregoing configuration, the image generating circuit generates an image in an intermediate frame that is just between the current frame and the next frame. Such an image in an intermediate frame is suitably used as an interpolating image that interpolates between the image in the current frame and the image in the next frame.

This makes it possible to achieve a stereoscopic image display device with improved display quality of moving images and improved viewability of moving images.

The stereoscopic image display device of the present invention is preferably configured such that either of the left-eye and right-eye images is an image acquired at an intermediate timing between the timing at which the image in the current frame of the other image was acquired and the timing at which the image in the next frame of the other image was acquired.

In the stereoscopic image display device of the present invention, either of the left-eye and right-eye images is an image acquired at an intermediate timing just between the timing at which the image in the current frame of the other image was acquired and the timing at which the image in the next frame of the other image was acquired. Such an image is suitably used as an interpolating image that interpolates between the image in the current frame of the other image and the image in the next frame of the other image.

This makes it possible to achieve a stereoscopic image display device with improved display quality of moving images and improved viewability of moving images.

The stereoscopic image display device of the present invention is preferably configured such that the display section is a liquid crystal display panel.

According to the foregoing configuration, the display section used is a liquid crystal display panel that is thin display means. This makes it possible to achieve a stereoscopic image display device including a thin display section.

The stereoscopic image display device of the present invention is preferably configured such that the display section is a display panel including an organic light-emitting layer.

According to the foregoing configuration, the display section used is a display panel including an organic light-emitting layer. This makes it possible to prevent a problem with a ghost from occurring due to a problem with response time peculiar to liquid crystals, and to achieve a stereoscopic image display device including a thin display section.

The stereoscopic image display device of the present invention is preferably configured such that the light intensity adjusting section is a light-scattering liquid crystal element.

By using, as the light intensity adjusting section, a light-scattering liquid crystal element that transmits or scatters light, the foregoing configuration can significantly improve transmittance during transmission as compared with the case of use of a liquid crystal shutter including a polarizer and utilizing polarization, thus making it possible to achieve a stereoscopic image display device with increased brightness.

A possible example of the light-scattering liquid crystal element is, but is not limited to, a polymer-dispersed liquid crystal element.

The stereoscopic image pickup device of the present invention is configured such that either of the first and second image data pickup sections acquires image data at an intermediate timing between a timing at which the other image data pickup section acquires image data in the current frame and a timing at which the other image data pickup section acquires image data in the next frame.

The stereoscopic image display device is configured such that of the first image data pickup section which acquires data for a left-eye image and the second image data pickup section which acquires data for a right-eye image, the first image data pickup section acquires image data at an intermediate timing just between a timing at which the second image data pickup section acquires image data in the current frame and a timing at which the second image data pickup section acquires image data in the next frame.

Such image data acquired by the first image data pickup section is suitably used as an interpolating image that interpolates between images in the current and next frames as acquired by the second image data pickup section.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

The present invention is applicable to a stereoscopic image display device, a stereoscopic image pickup device, a television receiver, a game apparatus, a recording medium, and a method for transmitting a stereoscopic image.

### REFERENCE SIGNS LIST

1, 1a, 1b Stereoscopic image display device
2 Liquid crystal display panel (display section)
2a Display surface
3 Shutter glasses (light intensity adjusting section)
4 Liquid crystal display panel driving circuit
5 Shutter glasses driving circuit
6 Stereoscopic camera (stereoscopic image pickup device)
6a Left-eye camera (first image data pickup section)
6b Right-eye camera (second image data pickup section)
7 Image processing circuit
8 Recording medium playback device
9, 9a Frame interpolation circuit (image generating circuit)
S Subject

1. A stereoscopic image display device comprising:
a display section having a display surface on which left-eye and right-eye images are alternately displayed in a constant cycle, the left-eye and right-eye images being each an image taken from a different point of view from the other; and
a light intensity adjusting section, placed between the display surface and the left and right eyes of a viewer who looks at the display surface, which adjusts an amount of emitted light from the display surface in synchronization with the constant cycle, so that the viewer is able to see the left-eye image with the left eye alone while the left-eye image is being displayed on the display surface and see the right-eye image with the right eye alone while the right-eye image is being displayed on the display surface,
either of the left-eye and right-eye images being an image that interpolates between an image in the current frame of the other image and an image in the next frame of the other image.

2. The stereoscopic image display device as set forth in claim 1, further comprising an image generating circuit which generates either of the left-eye and right-eye images by predicting, in accordance with an image in the current frame and an image in the next frame of the other image as taken from the different point of view, an image between the image in the current frame and the image in the next frame as taken from the different point of view.

3. The stereoscopic image display device as set forth in claim 1, further comprising an image generating circuit which generates either of the left-eye and right-eye images by predicting, in accordance with an image in the current frame of the other image and an image in the next frame of the other image, an image between the image in the current frame of the other image and the image in the next frame of the other image.

4. The stereoscopic image display device as set forth in claim 1, wherein either of the left-eye and right-eye images is an image acquired between a timing at which the image in the current frame of the other image was acquired and a timing at which the image in the next frame of the other image was acquired.

5. The stereoscopic image display device as set forth claim 2, wherein the image generating circuit generates an image in an intermediate frame that is between the current frame and the next frame.

6. The stereoscopic image display device as set forth in claim 4, wherein either of the left-eye and right-eye images is an image acquired at an intermediate timing between the timing at which the image in the current frame of the other image was acquired and the timing at which the image in the next frame of the other image was acquired.

7. The stereoscopic image display device as set forth in claim 1, wherein the display section is a liquid crystal display panel.

8. The stereoscopic image display device as set forth in claim 1, wherein the display section is a display panel including an organic light-emitting layer.

9. The stereoscopic image display device as set forth in claim 1, wherein the light intensity adjusting section is a light-scattering liquid crystal element.

10. A television receiver comprising a stereoscopic image display device as set forth claim 1.

11. A game apparatus comprising a stereoscopic image display device as set forth in claim 1.

12. A recording medium containing data for left-eye and right-eye images,
the left-eye and right-eye images being each an image taken from a different point of view from the other,
either of the left-eye and right-eye images being an image that interpolates between an image in the current frame of the other image and an image in the next frame of the other image.

13. A method for transmitting a stereoscopic image, comprising the step of transmitting data for left-eye and right-eye images,
the left-eye and right-eye images being each an image taken from a different point of view from the other,
either of the left-eye and right-eye images being an image that interpolates between an image in the current frame of the other image and an image in the next frame of the other image.

14. A stereoscopic image pickup device comprising:
a first image data pickup section which acquires image data of a subject; and
a second image data pickup section which acquires image data of the subject from a different point of view,
either of the first and second image data pickup sections acquiring image data at a different timing from the other image data pickup section.

15. The stereoscopic image pickup device as set forth in claim 14, wherein either of the first and second image data pickup sections acquires image data at an intermediate timing between a timing at which the other image data pickup section acquires image data in the current frame and a timing at which the other image data pickup section acquires image data in the next frame.
